(19) United States
(12) Patent Application Publication
(10) Pub. No.: US 2009/0264800 A1
(43) Pub. Date: Oct. 22, 2009

(54) THERAPEUTIC SYSTEM AND METHOD FOR IMPROVING EYE-TRACKING SKILLS

(76) Inventor: Jacob Gestetner, Monroe, NY (US)

Correspondence Address: Jacob Gestetner, 8 Fillmore Court, #303, Monroe, NY, 10950, US

(21) Appl. No.: 12/106,249

(22) Filed: Apr. 18, 2008

(51) Int. Cl. A61H 5/00

(52) U.S. Cl. 601/37; 351/203

(57) ABSTRACT

A method for creating worksheets for eye-tracking therapy includes steps of specifying a pattern including a plurality of characters in an order for recognition. Steps generate at least one scramble of characters arranged in a plurality of rows containing a plurality of characters where the pattern is contained in the scramble in the order. Steps present the scramble in the worksheet for training eyes of a person to make correct saccadic movements by recognizing the pattern in the order.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to vision therapy or exercise for eye-tracking skills. More particularly, the invention relates to software that helps in creating worksheets geared towards therapy for improving eye-tracking skills.

### BACKGROUND OF THE INVENTION

Some people experience saccadic/fixation difficulties, which are difficulties performing quick movements of both eyes in the same direction. Individuals exhibiting poor saccadic, or eye-tracking, movements may also experience difficulty reading. For example, without limitation, it may be difficult for these people to stay on line or skip to next line while reading. Such people often reread words or lines.

A treatment for poor saccadic movements is to do activities aimed at improving this skill. These activities typically involve sophisticated exercises done at the Optometrist office or with an Occupational therapist or other professionals such as, but not limited to, vision therapists or teachers. Also, parents may wish to perform these activities with their children. Some activities involve the person scanning a worksheet to find target letters, numbers, or symbols at desired speeds.

Known techniques for eye-tracking therapy include the use of workbooks comprising ready-made worksheets of symbols, upper and lower case letters, and numbers. Some letters or numbers on these worksheets are underlined while the rest of the text is not. The task is to look at each object while concentrating on moving the eyes and not the head and to read aloud the underlined objects. In some of these worksheets, there is a pattern on top of each worksheet that the person must locate in an array of text below the pattern. The above-motioned workbooks are designed to improve eye-tracking skills while also targeting other skills such as, but not limited to, discrimination, sequencing, and memorization. The setback of these workbooks is that all of the sheets are limited to pre-printed designs; nothing can be changed, making it too simple for some readers or too difficult for others. Furthermore, some people may become quickly bored by these worksheets, and if a person struggling with eye-tracking problems works with a sheet that is not designed to their specific level of functioning, the therapy does not perform optimally.

Another setback of some of these worksheets is for people who read multiple languages where one language reads from left-to-right, for example, without limitation, English, while the other language reads from right-to-left, for example, without limitation, Hebrew or Arabic. Such people may have a tendency to read numbers, symbols and English alphabet from left-to-right and only the other language letters in the other direction. This phenomenon creates confusion for such persons when using these ready-made workbooks even when using symbols and numbers.

In view of the foregoing, there is a need for improved techniques for creating worksheets for eye-tracking therapy that enables the creator to easily customize the worksheets according to the needs of the particular client.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary worksheet created by eye-tracking therapy software, in accordance with an embodiment of the present invention;

FIG. 2 illustrates exemplary menus and shortcut buttons for an eye-tracking therapy software program, in accordance with an embodiment of the present invention;

FIGS. 3a and 3b illustrate an exemplary open tracking set window from an eye-tracking therapy software program, in accordance with an embodiment of the present invention. FIG. 3a shows a new tab of the open tracking set window, and FIG. 3b shows an existing tab of the open tracking set window;

FIG. 4 illustrates an exemplary tracking properties window from an eye-tracking therapy software program, in accordance with an embodiment of the present invention;

FIG. 5 illustrates an exemplary font window from an eye-tracking therapy software program, in accordance with an embodiment of the present invention;

FIG. 6 illustrates an exemplary page setup window from an eye-tracking therapy software program, in accordance with an embodiment of the present invention;

FIG. 7 illustrates an exemplary print preview window from an eye-tracking therapy software program, in accordance with an embodiment of the present invention;

FIG. 8 illustrates an exemplary print multiple sheets window from an eye-tracking therapy software program, in accordance with an embodiment of the present invention; and

FIG. 9 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a therapeutic system and method for improving eye-tracking skills is presented.

In one embodiment, a method for creating worksheets for eye-tracking therapy is presented. The method includes steps of specifying a pattern including a plurality of characters in an order for recognition, generating at least one scramble of characters arranged in a plurality of rows containing a plurality of characters where the pattern is contained in the scramble in the order and presenting the at least one scramble in the worksheet for training eyes of a person to make correct saccadic movements by recognizing the pattern in the order. Other various embodiments further include steps of specifying a number of the rows and a number of the characters, specifying a size of the characters and specifying a language for the characters. Still other embodiments further include steps of specifying a number of scrambles to generate, specifying each of the scrambles to be different and specifying the pattern to be random and each of the scrambles contains a different random pattern. In yet other embodiments the order reads from left to right and the steps of presenting includes printing the scramble on paper.

In another embodiment, a method for creating worksheets for eye-tracking therapy is presented. The method includes steps for specifying a pattern including a plurality of characters, steps for generating at least one scramble of characters and steps for presenting the at least one scramble in the worksheet for training eyes of a person to make correct saccadic movements. Various other embodiments further include steps for specifying dimensions of the scramble, steps for specifying a language for the characters and steps for specifying a number of scrambles to generate.

In another embodiment, a computer program product for creating worksheets for eye-tracking therapy is presented. The product includes computer code for specifying a pattern including a plurality of characters in an order for recognition. Computer code generates at least one scramble of characters arranged in a plurality of rows containing a plurality of characters where the pattern is contained in the scramble in the order. Computer code presents the at least one scramble in the worksheet for training eyes of a person to make correct saccadic movements by recognizing the pattern in the order and a computer-readable medium that stores the computer code. Other embodiments further include computer code for specifying a number of the rows and a number of the characters, computer code for specifying a size of the characters and including computer code for specifying a language for the characters. Still other embodiments further include including computer code for specifying a number of scrambles to generate, computer code for specifying each of the scrambles to be different and computer code for specifying the pattern to be random and each of the scrambles contains a different random pattern.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

The preferred embodiment of the present invention provides a program designed to assist in the creation of worksheets for persons with saccadic/fixation difficulties. The preferred embodiment is also helpful in developing visual-motor integration skills.

Embodiments of the present invention address the limitations of previous published workbooks for eye-tracking therapy. Using embodiments of the present invention, one can create customized worksheets and unlimited amounts of worksheets. Features such as, but not limited to, font, text size, number of lines, number of characters per line, line spacing, etc. can all be set. Using embodiments of the present invention, a user can create a customized pattern. Once a pattern is chosen, the system generates a unique scramble of letters based on this pattern. This option facilitates an interest as the user can choose a word of interest to him or her as the pattern, such as, but not limited to, a name, a favorite object, etc. In various embodiment, the system may use letters, numbers, or a combination of both. Embodiments of the present invention may also be configured to work in both the left-to-right direction as well as the right-to-left direction.

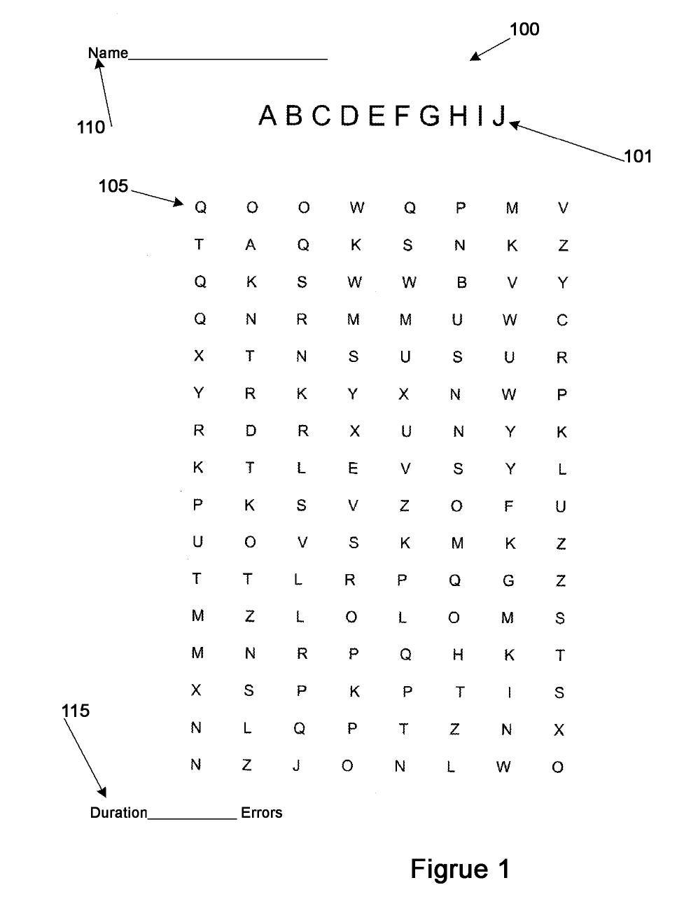

FIG. 1 illustrates an exemplary printed worksheet created by eye-tracking therapy software, in accordance with an embodiment of the present invention. This software enables an optometrist, occupational therapist, vision therapist, teacher, parent, etc. to design and print worksheets that train the eyes to make correct saccadic movements. In the present embodiment, the printed worksheet comprises a letter pattern 101 on the top of the page, and a scramble 105 of letters below. A reader's task is to quickly scan scramble 105 for the target letters in letter pattern 101 featured at the top of the worksheet. In the present embodiment, letter pattern 101 indicates the reader to locate the letters A, B, C, D, E, F, G, H, I, and J in that order. As the reader locates the correct letters he/she may circle or highlight the letters. The worksheet in the present embodiment also comprises a header 110 at the top of the page and a footer 115 at the bottom of the page. In the present embodiment, header 110 is designed for the reader to write their name on the worksheet, and footer 115 enables the length of time the exercise lasted and the number of errors made by the reader. This enables the performance and progress of the reader throughout the therapy.

The software can be adapted to meet individual needs. The layout of the worksheet can be customized to control features such as, but not limited to, the number of letters per line as well as the number of rows in scramble 105. Reducing the number of letters per line reduces the “crowding effect”, and reducing the number of rows in scramble 105 reduces the “visual clutter.” The size of the font may also be changed to foster visual discrimination. Scramble 105 may be presented with various types of characters, for example, without limitation, English, Arabic, Japanese, Chinese, or Hebrew letters, to accommodate the language needs of the reader. In some embodiments, the scramble may comprise numbers or symbols rather than letters. Furthermore, the software is easy to operate, as scramble 105 can be quickly scrambled again to produce a new scramble, and specific words can be introduced as the sample pattern for the letter search to help hold the reader's interest.

If a user wishes to create worksheets using characters other than English characters, for example, without limitation, Hebrew or Arabic characters, the computer system on which the software is running must be configured to recognize the alternate characters. The present example provides steps to set up the computer system running a Windows platform to recognize Hebrew characters. In the control panel menu, the regional and languages icon is selected. The languages tab of the regional and languages option window is chosen and, under the heading supplemental language support, the box to install files for complex script and right-to-left languages (including Thai) is checked. Finally the apply button is clicked. Once the computer system is configured, the keyboard may need to be configured to recognize Hebrew. Under the languages tab in the regional and languages option window, the details button is clicked under the text services and input languages heading. Under the heading installed services, Hebrew is chosen. If Hebrew, is not listed, it may be added by clicking on the add button. Under the advanced tab, Hebrew may be set as the default language for Non-Unicode programs. If this option is chosen, worksheets created using the software according to the present embodiment may be named and saved using Hebrew text. In order to do this, it may be necessary to change a setting in a help menu within the software to Unicode use. Similar steps may be performed in various embodiments to enable the user to create worksheets using various different languages, and these steps may differ depending on the type of computer system on which the software is running.

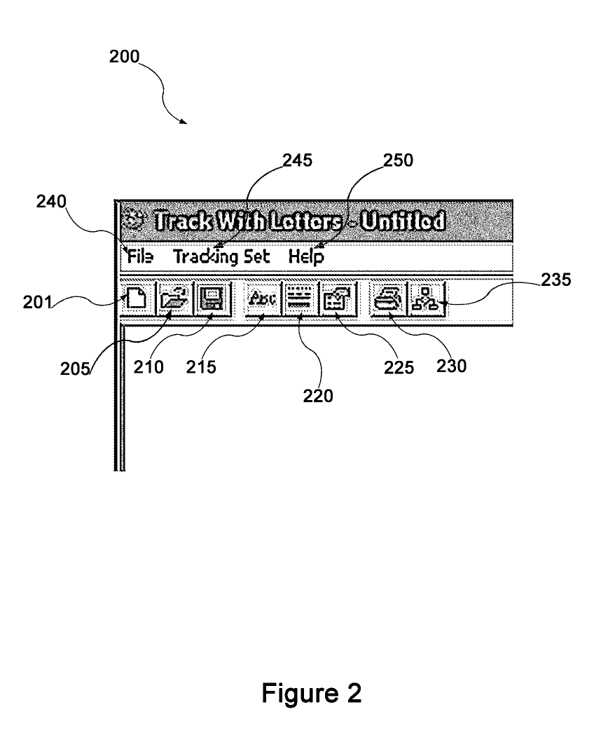

FIG. 2 illustrates exemplary menus and shortcut buttons for an eye-tracking therapy software program, in accordance with an embodiment of the present invention. In the present embodiment there are shortcuts to commonly used program commands at the top left corner of the screen in the form of buttons with graphic symbols. In the order of left to right, the shortcut buttons comprise a new tracking set button 201, an open tracking set button 205, a save tracking set button 210, a generate pattern button 215, a generate scramble button 220, a tracking set properties button 225, a print button 230, and a print multiple sheets button 235. The functions of these buttons are described by way of example in reference to the subsequent figures. Those skilled in the art, in light of the present teachings, will recognize that various embodiments may comprise additional, fewer or different shortcut buttons. For example, without limitation, some embodiments may comprise shortcut buttons for other commands such as, but not limited to, print preview, page setup, and help. Furthermore, some embodiments of the present invention may enable the user to customize the shortcut buttons to include the shortcuts that the user uses most often. These and other commands may also be found under the various menus located above these shortcut buttons.

The present embodiment comprises a file menu 240, a tracking set menu 245 and a help menu 250. In the present embodiment file menu 240 comprises a new pattern command, a new scramble command, a new tracking set command, an open command, a save command, a save as command, a page setup command, a print preview command, a print command, a print multiple sheets command, and an exit command. The exit command enables a user to exit the program. Tracking set menu 245 comprises a properties command. Help menu 250 comprises a support submenu and an about command. The support submenu comprises a Unicode command, an ASU command, an OMA command, and a key value test command. Generally, Unicode, ASU and OMA are computer language that system uses to understand the keyboard typing. Those skilled in the art will understand how use them as prescribed in the present embodiment. For example, without limitation, for the system to recognize the “Hebrew” fonts in the present embodiment it would be set to Unicode. Some computer, albeit rarely, may encounter technical difficulties with the Hebrew worksheet even if it is set to Unicode, a technician may direct to perform a test using the “Key Value test” button.

The about command of help menu 250 displays general information about the program including, without limitation, the version of the software, support contact information, copyright information, etc. The remaining commands listed in these menus are further described by way of example in reference to the subsequent figures. Those skilled in the art, in light of the present teachings, will recognize that alternate embodiments of the present invention may comprise alternate menus and commands depending on the particular implementation of the program.

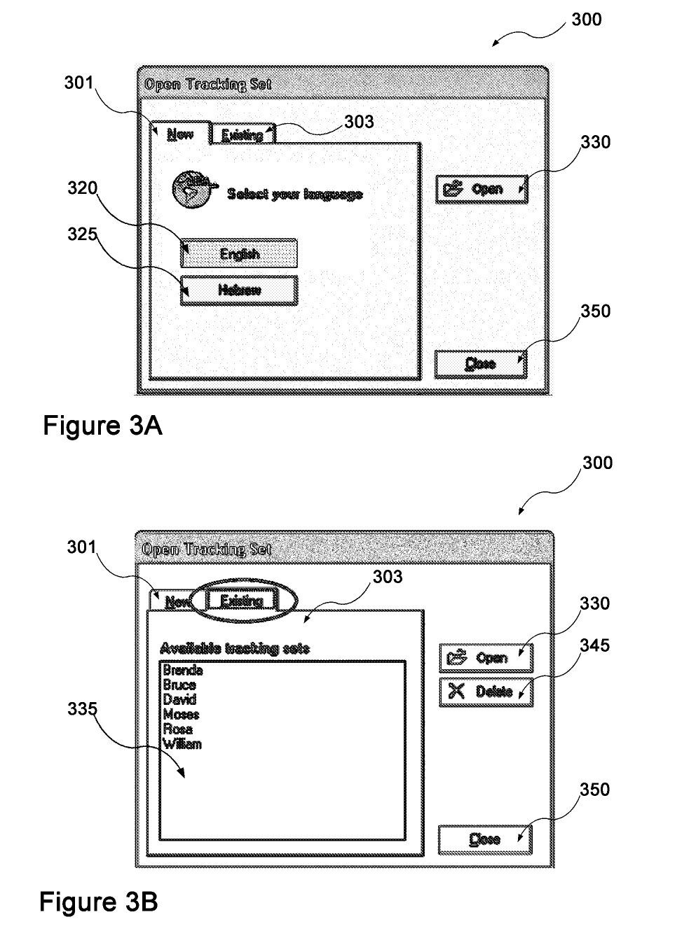

FIGS. 3a and 3b illustrate an exemplary open tracking set window 300 from an eye-tracking therapy software program, in accordance with an embodiment of the present invention. FIG. 3a shows a new tab 301 of open tracking set window 300, and FIG. 3b shows an existing tab 303 of open tracking set window 300. To open a tracking set in the present embodiment, the user first clicks an open shortcut button, for example, without limitation, open tracking set button 205 shown by way of example in FIG. 2, or clicks an open command in a file menu, for example, without limitation, file menu 240 shown by way of example in FIG. 2, and open tracking set menu 300 opens. This enables the user to create a new tracking set by clicking new tab 301 or to work with an existing tracking set by clicking existing tab 303. To create a new tracking set, the user must select the language that he wishes the program to use on new tab 301. In the present embodiment, the program is configured to create both English and Hebrew worksheets, and the user can click either an English button 320 or a Hebrew tab 325. In alternate embodiments that are not configured to create multiple languages, the user may not be required to select a language. In other alternate embodiments various different languages may be represented on the new tab such as, but not limited to Arabic, Japanese, Chinese, Russian, etc. Once the user makes these selections, the user clicks on an open button 330 to open the tracking set. To work with an existing tracking set the user can choose a tracking set from an available tracking set list 335 on existing tab 303. Once the user chooses a tracking set from list 335, the user may open the tracking set by clicking open button 330 or delete the tracking set by clicking a delete button 345. The user may also close open tracking set window 300 by clicking a close button 350.

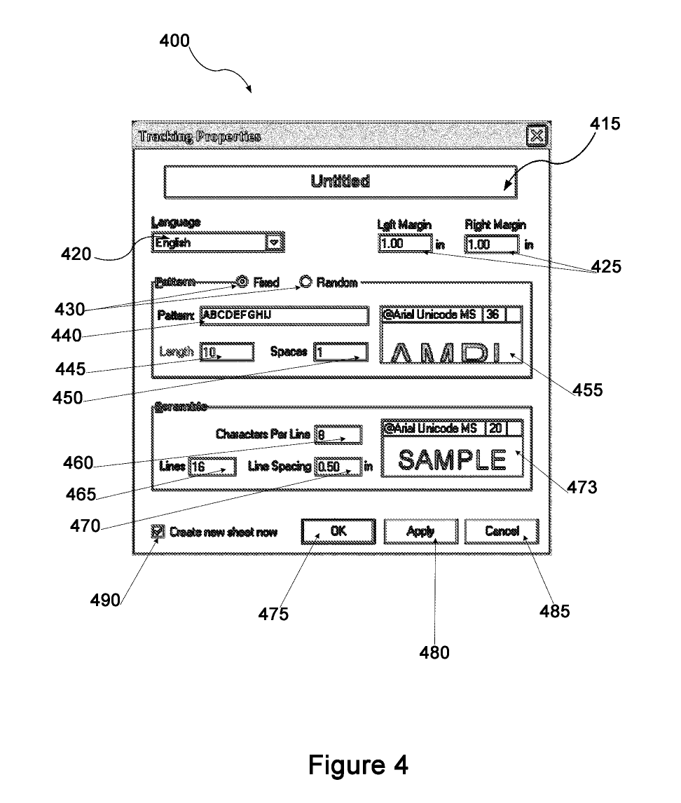

FIG. 4 illustrates an exemplary tracking properties window 400 from an eye-tracking therapy software program, in accordance with an embodiment of the present invention. To customize an individual worksheet, a user clicks on a tracking set properties shortcut button, for example, without limitation, tracking set properties button 225 shown by way of example in FIG. 2, or a properties command from a tracking set menu, for example, without limitation, tracking set menu 245 shown by way of example in FIG. 2. Tracking properties window 400 then appears.

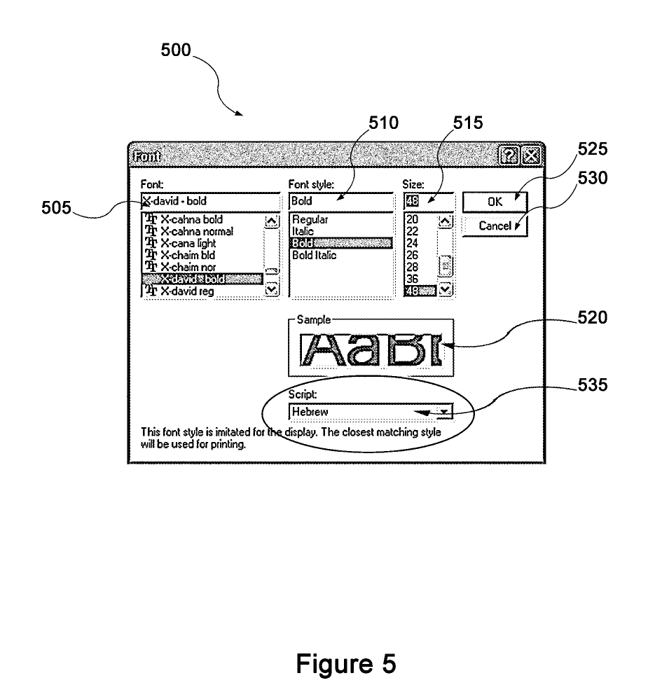

Tracking properties window 400 enables the user to name the tracking set by entering a name in a title field 415 in the uppermost space of tracking properties window 400. A language field 420 displays the language being used for the particular tracking set and enables the user to select different languages for the tracking set from a drop down menu. Embodiments not enabling the use of different languages may not include a language field. In margin fields 425 in the present embodiment, the user may set the right and left margins by entering the desired size of the margins in inches. Margins may be set using various different measurements in alternate embodiments, for example, without limitation, metric measurements, character spaces, etc. The margins entered in margin fields 425 are added to the printer margins. The user can choose a pattern setting 430 by selecting either random or fixed. If pattern setting 430 is set to fixed, the original pattern is maintained even as the scramble is changed, and if pattern setting 430 is set to random, the pattern changes randomly along with the scramble. In a pattern space 440 the user may enter a specific pattern or leave the default pattern in place. If pattern setting 430 is set to random, the user can choose a number of characters he would like in the pattern by entering the number a length field 445. The user may also enter the number of spaces he would like to separate the characters in the pattern by entering a number in a spaces field 450. In the present embodiment, the pattern font style and size is set to a default of Arial Unicode MS size 36. However, the user can change the font, style, and size by clicking on the default entry in a pattern font field 455, and a font window appears. A font window 500 is shown by way of example in FIG. 5. Pattern font field 455 also shows a sample of what the pattern font will look like using the settings chosen.

Using tracking properties window 400, the user may also change the settings of the scramble. In a scramble section, the user can choose the number of characters per line by entering a number in a characters per line field 460. With more characters per line, the intensity of the “crowding effect” is increased. The user may then choose the number of lines in the scramble by entering a number in a lines field 465. More lines in the scramble create more “visual clutter”. The user selects the spacing dimensions between the lines in the scramble by entering an amount in inches in a line spacing field 470. In alternate embodiments, line spacing may be set using various different measurements, for example, without limitation, metric measurements, character spaces, etc. In the present embodiment, the default font for the scramble is Arial Unicode MS size 20. However, the user may change the default font and font size of the scramble by selecting a scramble font field 473 in the scramble section. Clicking on scramble font field 473 causes a font window to appear, for example, without limitation, font window 500 shown by way of example in FIG. 5. Scramble font field 473 also shows a sample of what the scramble font will look like using the chosen settings. Changing the font of the scramble can help in the development of visual perception by changing between standard or ambiguous fonts. Once the user has set the parameters of the tracking set as desired, the user may click an OK button 475 to see the customized tracking set. The user may also click an apply button 480 to apply the settings to the tracking set or a cancel button 485 to cancel any changes made to the tracking set properties. In the present embodiment, when clicking the “apply” button while the “create new sheet now” is checked, a new sheet is created but the “Tracking Properties” window remains open to allow for proof-reading and make adjustment accordingly. When clicking on OK the “Tracking properties” window closes saving the new properties. Depending on the user's choice, a new sheet is created or the system keeps the new setting without creating the new sheet now but user can come back later do so. The present embodiment also comprises a check box to create a new sheet now 490.

The user may wish to make changes to the customized tracking set after setting all of the parameters. If pattern setting 430 is set to random, the user can change the pattern of the worksheet while still maintaining the selected settings by clicking on a new pattern command from a file menu, for example, without limitation, new pattern command in file menu 240 shown by way of example in FIG. 2, or by clicking a generate pattern button, for example, without limitation, generate pattern button 215 shown by way of example in FIG. 2. The user can change the scramble while still maintaining the selected settings by clicking on a new scramble command in a file menu, for example, without limitation, the new scramble command in file menu 240 shown by way of example in FIG. 2, or by clicking a generate scramble button, for example, without limitation, generate scramble button 220 shown by way of example in FIG. 2. To create a new tracking set, the user can click on a new tracking set command in a file menu, for example, without limitation, file menu 240 shown by way of example in Figure 2, or by clicking a new tracking set button, for example, without limitation, new tracking set button 201 shown by way of example in FIG. 2.

To save a tracking set, the user may click on a save command in a file menu, for example, without limitation, file menu 240 shown by way of example in FIG. 2, or by clicking a save button, for example, without limitation, save button 210 shown by way of example in FIG. 2. The program automatically saves the worksheet tracking set under the title in title field 415 on tracking properties window 400 or Untitled if no title is assigned. To save the tracking set under a specific title, the user clicks on a save as command in a file menu, for example, without limitation, file menu 240 shown by way of example in FIG. 2, to enter a specific title. To open an existing tracking set, the user clicks on an open command in a file menu, for example, without limitation, file menu 240 shown by way of example in FIG. 2, or the user clicks an open tracking set button, for example without limitation, open tracking set button 205 shown by way of example in FIG. 2, and an open tracking set window appears, for example, without limitation, open tracking set window 300 shown by way of example in FIG. 3. The user then clicks the existing tab to see a list of available tracking sets, and selects a tracking set from the list and clicks an open button to open the tracking set.

FIG. 5 illustrates an exemplary font window 500 from an eye-tracking therapy software program, in accordance with an embodiment of the present invention. If a user wishes to change the font or font size of the pattern or the scramble of a tracking set, the user can do so using font window 500. The font can be set by selecting a font from a list of available fonts in a font field 505. In a font style field 510, the user can choose from various font styles including, without limitation, regular, bold, italic, etc. The size of the font is set by selecting a size from a list of available sizes in a size field 515. A sample field 520 displays the font as defined by font field 505, font style field 510 and font size field 515. If the user wishes to keep the font properties selected, he may click an OK button 525. If not, the user may click a cancel button 530. Before choosing the font, the user may need to change the language selected in a script field 535 by selecting the language of the tracking set from a drop down menu of available languages. Choosing some languages may narrow the font choices.

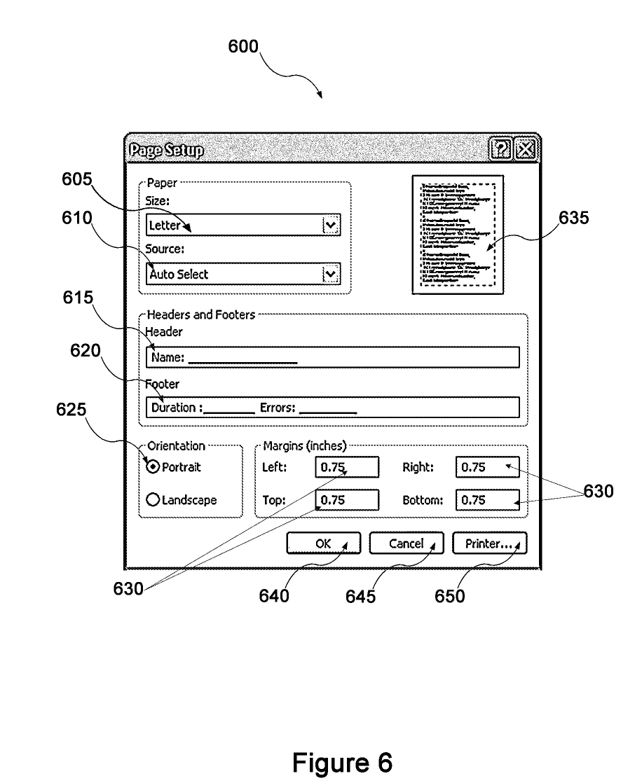

FIG. 6 illustrates an exemplary page setup window 600 from an eye-tracking therapy software program, in accordance with an embodiment of the present invention. In the present embodiment, a user selects page settings by clicking on a page setup command in a file menu, for example, without limitation, file menu 240 shown by way of example in FIG. 2, and page setup window 600 appears. Within page setup window 600, the user can select the size of paper on which he wishes to print a worksheet by selecting a paper size from the drop down menu in paper size field 605. The user also selects the source for the paper in from a drop down menu of available paper sources in a source field 610.

A header and footer may also be customized using a header field 615 and a footer field 620. As the default, the system is set to print on top of each page the name of the current tracking set and the page number, for example, without limitation, page 1 of 1, as the header and the file location and date, for example, without limitation, Dec. 21, 2007, as the footer. To enable this option, the following codes are stored in the corresponding fields as the default: &w&bPage &p of &P in header field 615 and &u&b&d in footer field 620. These codes may be used to restore to the system default whenever desired. The user can customize the header and footer by entering a word, phrase, symbols, etc. in header field 615 and footer field 620. This feature enables the user to label the type or setting of the individual worksheet as well as the name of the reader. A header enabling the reader to enter their name on the worksheet is shown by way of example in the present example. The user may also customize a footer that enables the user to mark the duration of reading time and the amount of errors by entering Duration ______ Errors ______ into footer field 620, as shown in the present example. This feature helps track the reader's performance and progress. These are exemplary uses for the header and footer, and users may use the header and footer for various other uses for example, without limitation, to indicate the test administrator, the difficulty level of the worksheet, etc. Changes to header field 615 and footer field 620 may affect any page printed using Internet Explorer in some computer systems. To correct this, the user can change the setting within Internet Explorer by clicking on a page setup command in a file menu in Internet Explorer to reach a page setup window for Internet Explorer. A list of codes that can be used in the header and footer fields in Internet Explorer may be found in an Internet Explorer help index under page set up printing web pages.

The user can choose between portrait and landscape for the orientation of the page with an orientation setting 625. The top, bottom, left, and right margins may also be set by entering a measurement in inches in the corresponding field in margin fields 630. Margins may be set using various different measurements in alternate embodiments, for example, without limitation, metric measurements, character spaces, etc. The margins entered in margin fields 630 are added to the printer margins. A sample of what the page will look like using the chosen settings is shown in a page setup sample 635. To apply the settings to the worksheet, the user clicks an OK button 640, or the user may click a cancel button 645 to cancel the settings. In the present embodiment, the user may access printer settings by clicking a printer button 650.

The user can print a tracking set by clicking on a print command under a file menu, for example, without limitation, file menu 240 shown by way of example in FIG. 2, or the user can click a print shortcut button, for example, without limitation, print button 230 shown by way of example in FIG. 2. The user also has the option to see a preview of the worksheet before printing and to print multiple worksheets.

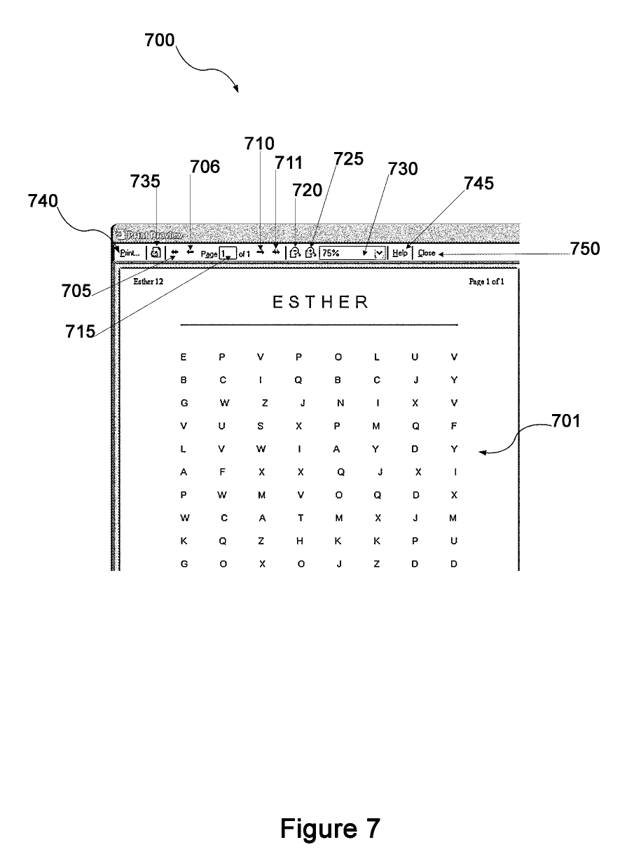

FIG. 7 illustrates an exemplary print preview window 700 from an eye-tracking therapy software program, in accordance with an embodiment of the present invention. To see a preview 701 of the worksheet before printing, the user clicks on a print preview command in a file menu, for example, without limitation, file menu 240 shown by way of example in FIG. 2. In the present embodiment, print preview window 700 enables the user to toggle back and forth between pages using backward buttons 705 and 706 and forward buttons 710 and 711 if there are multiple pages. Backward button 705 takes the user to page one, and backward button 706 takes the user backward one page at a time. Forward button 710 takes the user forward one page at a time, and forward button 711 takes the user to the final page. In this example there is only one page (page one of one), however, when the user chooses, for example, 100 line per scramble, then there is more than one page and you are correct with description of buttons. A page field 715 indicates which page is currently being displayed and enables the user to enter a page number to go directly to that page. A zoom in button 720, a zoom out button 725, and a percentage zoom scale field 730 enables the user to change the size of preview 701.

The present embodiment also enables the user to bring up a page setup window within print preview window 700, for example without limitation, page setup window 600 shown by way of example in FIG. 6, by clicking a page setup button 735. If the user is satisfied with preview 701, the user can print a worksheet directly from print preview window 700 by clicking a print button 740. If the user needs help while in print preview window 700, the user may click a help button 745, and the user may close print preview window 700 by clicking a close button 750. Those skilled in the art, in light of the present teachings will recognize that various other commands and shortcut buttons may be included in print preview windows in alternate embodiments such as, but not limited to, commands to switch back and forth between portrait and landscape, a command to view multiple pages in one view, a shrink to fit button, etc. Furthermore some embodiments of the present invention may not include a print preview feature.

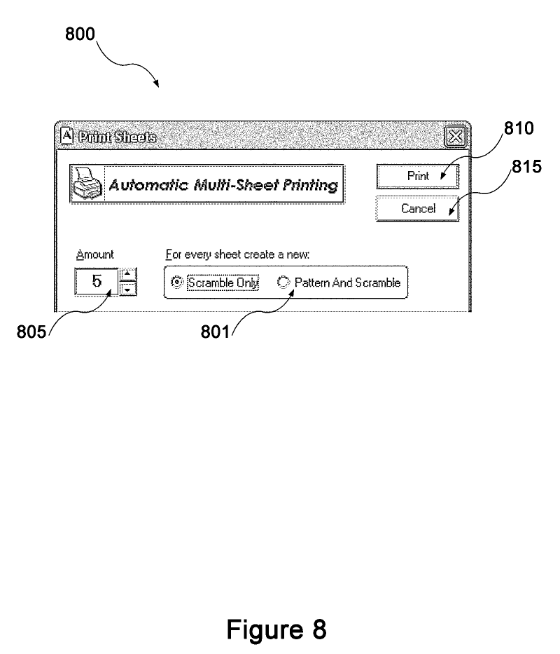

FIG. 8 illustrates an exemplary print multiple sheets window 800 from an eye-tracking therapy software program, in accordance with an embodiment of the present invention. This feature enables a user to print multiple sheets containing different patterns and/or scrambles, depending on a pattern setting 801, with a click of the mouse. In order to bring up print multiple sheets window 800, the user clicks on a print multiple sheets command in a file menu, for example without limitation, file menu 240 shown by way of example in FIG. 2, or the user may click a print multiple sheets button, for example, without limitation, print multiple sheets button 235 shown by way of example in FIG. 2. On print multiple sheets window 800, the user can choose the number of worksheets that the user wishes to print in an amount field 805. The user can choose to change only the scramble for each sheet printed or may choose to change the pattern and the scramble for each sheet printed using pattern setting 801. In some embodiments the user may not be able to choose to change the pattern and scramble for each sheet if the pattern setting in the tracking set properties is set to fixed, for example, without limitation, pattern setting 430 shown by way of example in FIG. 4. Once the user has selected the desired number of sheets in amount field 805 and the desired pattern setting 801, the user may click a print button 810. The system then generates and prints the desired number of worksheets. If the user decides not to print multiple worksheets once print multiple sheets window 800 is open, the user may click a cancel button 815 to close print multiple sheets window 800. Alternate embodiments may not include an automatic multiple sheet printing feature.

Those skilled in the art, in light of the present teachings, will recognize that the windows, menus and commands described above in reference to the figures represent exemplary implementations and that many alternate implementations are possible. For example, without limitation, alternate embodiments may enable various different commands and menus depending on the needs of the user of the software such as, but not limited to, a print menu, separate windows for the pattern properties and the scramble properties, an index in the help menu, etc. Also, alternate embodiments may have various different fields, settings, and buttons in some of the windows such as, but not limited to, a difficulty level setting on the tracking set properties menu that automatically sets the properties of the pattern and scramble depending on the difficulty level chosen, a right-to-left or left-to-right setting on the tracking set properties menu, a setting to set the letters in the pattern and the scramble to all uppercase, all lowercase or mixed, a printer button on the print multiple sheets window that enables the user to access printer settings, etc. Furthermore, the windows may have various different appearances depending on the fields and settings included and the preferences of the user. For example, without limitation, in alternate embodiments the open tracking set menu may not comprise a separate tab for new and existing tracking sets and instead comprise an open new button along with a list of existing tracking sets within the same window. Some embodiments may enable the user to customize the look and available features of the windows, menus and shortcut buttons.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like.

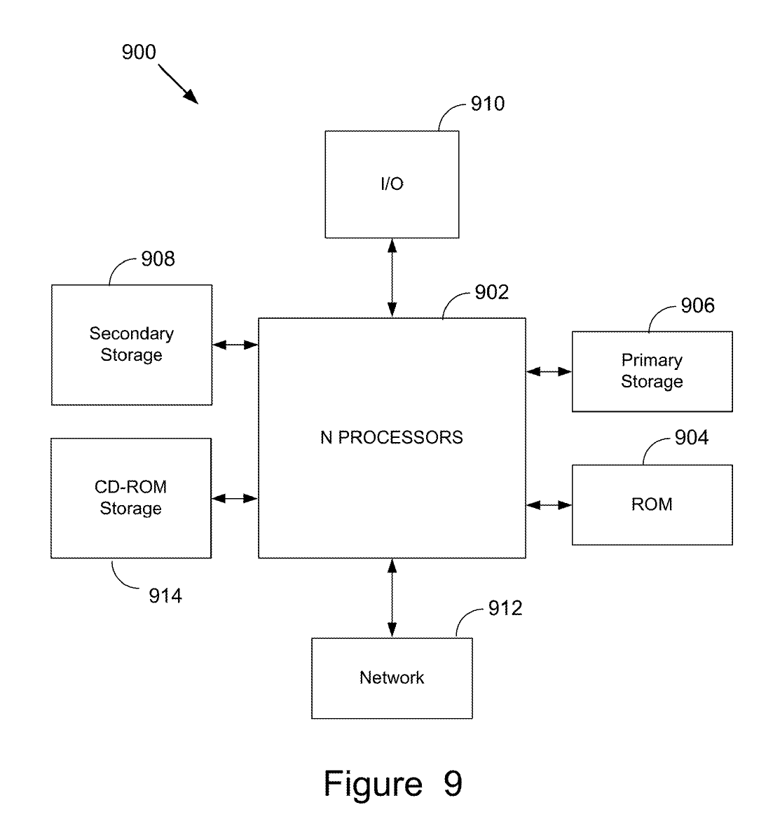

FIG. 9 illustrates a typical computer system that, when appropriately configured or designed, can serve as a computer system in which the invention may be embodied. The computer system 900 includes any number of processors 902 (also referred to as central processing units, or CPUs) that are coupled to storage devices including primary storage 906 (typically a random access memory, or RAM), primary storage 904 (typically a read only memory, or ROM). CPU 902 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 904 acts to transfer data and instructions uni-directionally to the CPU and primary storage 906 is used typically to transfer data and instructions in a bi-directional manner. Both of these primary storage devices may include any suitable computer-readable media such as those described above. A mass storage device 908 may also be coupled bi-directionally to CPU 902 and provides additional data storage capacity and may include any of the computer-readable media described above. Mass storage device 908 may be used to store programs, data and the like and is typically a secondary storage medium such as a hard disk. It will be appreciated that the information retained within the mass storage device 908, may, in appropriate cases, be incorporated in standard fashion as part of primary storage 906 as virtual memory. A specific mass storage device such as a CD-ROM 914 may also pass data uni-directionally to the CPU.

CPU 902 may also be coupled to an interface 910 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 902 optionally may be coupled to an external device such as a database or a computer or telecommunications or internet network using an external connection as shown generally at 912, which may be implemented as a hardwired or wireless communications link using suitable conventional technologies. With such a connection, it is contemplated that the CPU might receive information from the network, or might output information to the network in the course of performing the method steps described in the teachings of the present invention.

Having fully described at least one embodiment of the present invention, other equivalent or alternative methods of providing software to create worksheets for eye-tracking therapy according to the present invention will be apparent to those skilled in the art. The invention has been described above by way of illustration, and the specific embodiments disclosed are not intended to limit the invention to the particular forms disclosed. For example, the particular implementation of the program may vary depending upon the particular type of computer operating system used. The embodiments described in the foregoing were directed to Windows implementations; however, similar techniques are to implement programs using various other computer systems such as, but not limited to, Macintosh, etc. Non-Windows implementations of the present invention are contemplated as within the scope of the present invention. The invention is thus to cover all modifications, equivalents, and alternatives falling within the spirit and scope of the following claims.

What is claimed is:

1. A method for creating worksheets for eye-tracking therapy, the method comprising steps of:
specifying a pattern comprising a plurality of characters in an order for recognition;
generating at least one scramble of characters arranged in a plurality of rows containing a plurality of characters where said pattern is contained in said scramble in said order; and
presenting said at least one scramble in the worksheet for training eyes of a person to make correct saccadic movements by recognizing said pattern in said order.

2. The method as recited in claim 1, further comprising steps of specifying a number of said rows and a number of said characters.

3. The method as recited in claim 1, further comprising steps of specifying a size of said characters.

4. The method as recited in claim 1, further comprising steps of specifying a language for said characters.

5. The method as recited in claim 1, further comprising steps of specifying a number of scrambles to generate.

6. The method as recited in claim 5, further comprising steps of specifying each of said scrambles to be different.

7. The method as recited in claim 5, further comprising steps of specifying said pattern to be random and each of said scrambles contains a different random pattern.

8. The method as recited in claim 1, wherein said order reads from left to right.

9. The method as recited in claim 1, wherein said steps of presenting comprises printing said scramble on paper.

10. A method for creating worksheets for eye-tracking therapy, the method comprising:
steps for specifying a pattern comprising a plurality of characters;
steps for generating at least one scramble of characters; and
steps for presenting said at least one scramble in the worksheet for training eyes of a person to make correct saccadic movements.

11. The method as recited in claim 10, further comprising steps for specifying dimensions of said scramble.

12. The method as recited in claim 10, further comprising steps for specifying a language for said characters.

13. The method as recited in claim 10, further comprising steps for specifying a number of scrambles to generate.

14. A computer program product for creating worksheets for eye-tracking therapy, the product comprising:
computer code for specifying a pattern comprising a plurality of characters in an order for recognition;
computer code for generating at least one scramble of characters arranged in a plurality of rows containing a plurality of characters where said pattern is contained in said scramble in said order;
computer code for presenting said at least one scramble in the worksheet for training eyes of a person to make correct saccadic movements by recognizing said pattern in said order; and
a computer-readable medium that stores the computer code.

15. The product as recited in claim 14, further comprising computer code for specifying a number of said rows and a number of said characters.

16. The product as recited in claim 14, further comprising computer code for specifying a size of said characters.

17. The product as recited in claim 14, further comprising computer code for specifying a language for said characters.

18. The product as recited in claim 14, further comprising computer code for specifying a number of scrambles to generate.

19. The product as recited in claim 18, further comprising computer code for specifying each of said scrambles to be different.

20. The product as recited in claim 18, further comprising computer code for specifying said pattern to be random and each of said scrambles contains a different random pattern.
